(19) United States
(12) Patent Application Publication
(10) Pub. No.: US 2026/0163268 A1
(43) Pub. Date: Jun. 11, 2026

(54) ELECTRICAL PLUG CONNECTOR AND SET HAVING AN ELECTRICAL PLUG CONNECTOR AND AN ACCESSORY PART

(71) Applicant: WAGO Verwaltungsgesellschaft mbH, Minden (DE)

(72) Inventors: Robin UPMANN, Minden (DE); Rudolf MASTEL, Minden (DE); Thomas RANIS, Minden (DE)

(73) Assignee: WAGO Verwaltungsgesellschaft mbH, Minden (DE)

(21) Appl. No.: 19/413,323

(22) Filed: Dec. 9, 2025

(30) Foreign Application Priority Data
Dec. 10, 2024 (DE) 20 2024 107 164.6

(51) Int. Cl. H01R 12/70

(52) U.S. Cl. CPC H01R 12/7064

(57) ABSTRACT

An electrical plug connector, including an insulating housing with a first housing section and a second housing section as well as including a contact insert received in the insulating housing. The contact insert has a conductor connection arranged in the first housing section and a contact pin connection arranged in the second housing section. The insulating housing has a conductor insertion side in the first housing section with a conductor insertion opening for inserting an electrical conductor and having a contact pin insertion side in the second housing section with a contact pin insertion opening for inserting a contact pin. A set having an electrical plug connector of this type and having an accessory part are also provided.

This nonprovisional application claims priority under 35 U.S.C. § 119(a) to German Patent Application No. 20 2024 107 164.6, which was filed in Germany on Dec. 10, 2024, and which is herein incorporated by reference.

### BACKGROUND OF THE INVENTION

### Field of the Invention

The invention relates to an electrical plug connector, including an insulating housing with a first housing section and a second housing section as well as including a contact insert received in the insulating housing, the contact insert having a conductor connection arranged in the first housing section and a contact pin connection arranged in the second housing section, and the insulating housing having a conductor insertion side in the first housing section with a conductor insertion opening for inserting an electrical conductor and having a contact pin insertion side in the second housing section with a contact pin insertion opening for inserting a contact pin. The invention also relates to a set having an electrical plug connector of this type and having an accessory part.

### Description of the Background Art

Electrical plug connectors are known from electrical connecting systems. They are used as electromechanical connection components for connecting flexible and rigid electrical conductors for the purpose of establishing an electrical connection and are characterized by a secure contacting and comfortable handling, due to continuously further developed plug connection mechanisms.

During the installation, electrical plug connectors are frequently fastened to a mounting surface of a carrier structure to arrange and fix them securely in their operational environment in a defined way. A mounting surface of this type may be, for example, a housing surface of an electrical device or a printed circuit board surface of a printed circuit board. To reduce the installation work and speed up the mounting process, efforts are made to further develop the mounting solutions already available for electrical plug connectors and to continuously improve them with regard to structural and easy-to-operate mounting approaches. In addition, a highly flexible use and variety of functions, along with a compact design of the electrical plug connector, are desirable in practice.

### SUMMARY OF THE INVENTION

It is therefore an object of the present invention is to provide a compact, easy-to-handle, in particular easy-to-mount, electrical plug connector and also to optionally expand the functionality of the electrical plug connector for different installation requirements. The object of the invention is furthermore to provide a set having an electrical plug connector and an accessory part, with the aid of which the ability to handle the electrical plug connector and its range of functions may be flexibly improved.

According to an example of the invention, an electrical plug connector is proposed, which includes an insulating housing having a first housing section and a second housing section, as well as including a contact insert received in the insulating housing, the contact insert having a conductor connection arranged in the first housing section and a contact pin connection arranged in the second housing section, and the insulating housing having a conductor insertion side in the first housing section with a conductor insertion opening for inserting an electrical conductor and having a contact pin insertion side in the second housing section with a contact pin insertion opening for inserting a contact pin, a form-fitting element being formed on the second housing section, which is configured for an interaction with a mating form-fitting element formed on a mounting surface and/or on a connecting element for the purpose of fixing the plug connector on a carrier structure.

In simplified terms, it is proposed that the electrical plug connector can have a fastening contour in a housing region assigned to the contact pin connection, which is configured to establish a form-fitting connection to a mating contour, the mating contour being able to be arranged on a mounting surface of the carrier structure and/or on a separate connecting element, via which the plug connector may be fastened to the carrier structure. The electrical plug connector may have, in particular, multiple form-fitting elements, which may be formed, in particular, in different regions of the second housing section, so that the form-fitting connection may be established either via a mating form-fitting element on the mounting surface and/or via a mating form-fitting element on the connecting element.

The electrical plug connector according to the proposed features has the advantage that it may be easily mounted in a defined manner on the carrier structure. In particular, a precise and secure alignment of the second housing part with a contact pin arranged on the carrier structure or with a contact pin strip arranged on the carrier structure may be ensured, due to the formation of the form-fitting element in the second housing section, in which the contact pin connection is provided. For example, the contact pin insertion opening provided in the second housing section may also be precisely aligned with an existing contact pin in this way. By using a form-fitting element for fastening the plug connector on the carrier structure, an intuitive, in particular, tool-free and precisely oriented fastening of the plug connector on the carrier structure is made possible, the connection of the plug connector to the carrier structure being able to be established directly via a mating form-fitting element arranged on the mounting surface or indirectly via a mating form-fitting element formed on a connecting element. Form-fitting elements may also be easily formed on an insulating housing, in particular, manufactured integrally therewith, for example by means of a correspondingly adapted injection mold. The form-fitting element may be designed to be comparatively small and yet effectuate an effective fastening of the plug connector on the carrier structure, so that the plug connector may be advantageously manufactured with a compact structural design. The form-fitting element or at least one additional form-fitting element on the second housing section may be optionally used to fix at least one accessory part, as explained in greater detail below, so that an expansion of the function of the plug connector with the aid of the accessory part and/or an indirect fixing of the plug connector on the carrier structure via an accessory part designed as a connecting element is/are possible if desired or as needed.

The electrical plug connector can include an insulating housing and a contact insert received in the insulating housing. The contact insert may be an electromechanical arrangement, which is electrically conductive, at least in sections, and which is configured to form a conductor connection and a contact pin connection and to establish an electrically conductive connection between the conductor connection and the contact pin connection. A conductor connection may be, in particular, an electromechanical connection, which is configured to connect a flexible electrical conductor. A contact pin connection may be, in particular, an electromechanical connection, which is configured to connect a rigid electrical conductor. The contact insert may have, for example, an electrically conductive busbar. The contact insert may have, for example, a clamping spring for connecting a flexible electrical conductor on the busbar. The contact insert may have, for example, a socket contact for receiving a contact pin. The socket contact may have, for example, two elastically deflectable socket arms, which extend essentially in parallel to each other, for clamping a contact pin between the socket arms. The socket contact may be designed to be integral with the busbar.

The insulating housing receives the contact insert. In particular, the insulating housing completely surrounds the contact insert. The insulating housing may be, for example, a plastic housing. The insulating housing may protect the contact insert against environmental influences and against being touched. The insulating housing includes a first housing section and a second housing section. The first housing section and the second housing section divide the insulating housing into two different housing regions, which may be separated from each other along a mechanical or imaginary separation plane or, in other words, transition into each other along the separation plane. The conductor connection, for example a clamping spring of the conductor connection, is arranged in the first housing section, while the contact pin connection, for example a socket contact of the contact pin connection, is arranged in the second housing section. The contact pin connection may, in principle, also be partially arranged in the first housing section and protrude into the second housing section far enough that a contact pin inserted into the contact pin connection runs predominantly or exclusively through the second housing section. A busbar of the contact insert may extend in the first and second housing sections. The busbar may also be predominantly or completely arranged in the first housing section. In the case of a predominant arrangement of the busbar in the first housing section, the busbar may protrude partially into the second housing section from the first housing section. The insulating housing may be provided with a multi-part design, for example having a main housing part and a cover part, so that the contact insert is insertable into the main housing part and the latter is then able to be closed with the aid of the cover part. According to one design possibility, the second housing section may form the cover part for the first housing section designed as the main housing section.

Alternatively, the cover part may be able to be placed onto the main housing part, for example as a side cover part, and extend over the first and second housing sections. A form-fitting element can be formed on the second housing section. A form-fitting element of this type may be a geometrically specially designed region of the insulating housing, which is configured to establish a form-fitting mechanical connection to a mating form-fitting element geometrically adapted to the form-fitting element. The form-fitting element may be designed to be integral with the insulating housing. The form-fitting element and the mating form-fitting element may be suitable for engaging with each other or for fitting together, due to their geometric shape. Due to the shaping of the form-fitting element and the mating form-fitting element connected thereto, a relative movement of the form-fitting element and the mating form-fitting element may be blocked in at least one spatial direction. A transfer of force takes place via the contact faces of the form-fitting element and the mating form-fitting element which touch each other. As is explained farther below, the form-fitting element may have a positive form-fitting contour which projects with respect to an adjacent surface of the insulating housing, while the mating form-fitting element has a matching negative contour, which is suitable for receiving the form-fitting element. Alternatively, the form-fitting element may have a negative form-fitting contour which is recessed with respect to an adjacent surface of the insulating housing and may be suitable for receiving a mating form-fitting element having a matching positive form-fitting contour.

The mating form-fitting element may be arranged, for example, on a mounting surface of the carrier structure. The plug connector may be effectively and easily connected directly to the mounting surface by means of an interaction of the form-fitting element with the mating form-fitting element. The mating form-fitting element may be formed on a connecting element. The connecting element may have a fastening section for fastening the connecting element on the carrier structure. The fastening section may be connectable, in particular, to a mounting surface of the carrier structure. The fastening section may have a fastening element, such as a latching element, to be able to be fixed on the carrier structure. The connecting element may be connectable to the plug connector via the mating form-fitting element and to the carrier structure via the fastening element. In this way, the plug connector may be able to be indirectly fixed on the carrier structure via the connecting element. The connecting element may form an accessory part of the electrical plug connector.

The carrier structure may be, for example, a housing of an electrical device, a mounting plate, or a circuit carrier. The carrier structure may be, for example, a printed circuit board, so that the plug connector is configured for fastening on a printed circuit board. For example, at least one mating form-fitting element may be arranged on the printed circuit board for interaction with the form-fitting element of the second housing section of the plug connector. The printed circuit board may have a fixing element, for example a printed circuit board opening, via which a connecting element connectable to the plug connector may be connected to the printed circuit board.

The conductor connection may be configured for connecting an electrical conductor, which is insertable into the plug connector in a conductor insertion direction, and the contact pin connection may be configured for connecting a contact pin, which is inserted into the plug connector in a contact pin insertion direction, the conductor insertion direction and the contact pin insertion direction being able to run essentially perpendicularly to each other. The electrical conductor and the contact pin may therefore be insertable into the plug connector from different spatial directions. The handling of the plug connector may be simplified hereby, depending on the operational environment provided. For example, it may be conceivable that a contact pin or multiple contact pins, which may be arranged, in particular, on a contact pin strip, is or are arranged on the mounting surface of a carrier structure prior to the plug connector, and the plug connector is placed on the mounting surface in such a way that the contact pin or the contact pins is/are inserted into the second housing section and connected on a contact pin connection situated therein or on multiple contact pin connections. An electrical conductor provided for connection on the conductor connection may be insertable into the plug connector in a spatial direction deviating herefrom, for example essentially in parallel to the mounting surface. A connection of an electrical conductor is made easier hereby if the contact pin is already connected.

The conductor connection may be configured to connect contact pin to the plug connector approximately in parallel to and opposite from the contact pin insertion direction of the contact pin connection with its conductor insertion direction oriented for connecting an electrical conductor to the plug connector. The conductor insertion direction and the contact pin insertion direction are thus oriented essentially in parallel to each other. The conductor insertion may be arranged on the housing upper side, which is situated opposite the base side or the contact pin insertion side of the contact pin connection.

The conductor insertion side and the contact pin insertion side may extend in housing planes arranged essentially in parallel to each other. This also makes it possible for an electrical conductor provided for connection to the conductor connection and a contact pin provided for connection to the contact pin connection to be insertable into the plug connector from different spatial directions. The conductor insertion side may be formed, for example, by an essentially flat housing surface, in which the conductor insertion opening is formed for inserting the electrical conductor. The contact pin insertion side may be formed, for example, by an essentially flat housing surface, in which the contact pin insertion opening is formed for inserting a contact pin. The contact pin insertion side may face a mounting surface of the carrier structure, viewed, for example, in a mounting direction. The contact pin insertion side may be assigned, for example, to a base side of the plug connector. It is conceivable that the contact pin opening transitions into a through-channel, and a contact pin exit opening is formed on a housing surface of the second housing section situated opposite the contact pin insertion side. A contact pin connected to the contact pin connection may therefore extend through the second housing section and protrude partially therefrom.

The second housing section may be arranged on a plug connector side situated opposite the conductor insertion side. A transition between the first housing section and the second housing section may therefore face away from the conductor insertion side. A mechanical or imaginary separation plane between the first housing section and the second housing section may run in parallel to the conductor insertion side and be situated at a distance therefrom via a length of the first housing section. Due to an arrangement of the second housing section on a plug connector side situated opposite the conductor insertion side, the conductor connection function and the contact pin connection function of the plug connector may be situated at a distance from each other in a defined manner, by which means the handling of the plug connector is made easier and a spatial function separation is given.

The first housing section and the second housing section may be designed as separate housing components and be connected to each other. The contact insert may be easily inserted into the insulating housing hereby, for example into the first housing section, before the first housing section and the second housing section are connected to each other. The first housing section and the second housing section may be connectable to each other, for example via a materially bonded, force-fitting, and/or form-fitting connection. In principle, the first housing section and the second housing section may also be designed to be integral with each other. The first housing section may therefore directly materially transition into the second housing section. Due to an integral design of the first housing section and the second housing section, the plug connector may be easily manufactured in a compact manner as well as be robust and easy to handle. To insert the contact insert, a side, detachable cover part may be provided, which extends along the first and second housing sections.

The second housing section may have a form-fitting section on the second housing section, which is offset in a stepped manner and in which the at least one form-fitting element of the second housing section is formed. A defined connecting region may be provided hereby on the second housing section, so that different function regions on the plug connector are designed to be spatially separated from each other. In particular, multiple form-fitting elements of the same and/or different types may be formed in the form-fitting section. The stepped offset makes it possible to take into account the fact that an installation height is sufficient which is lower than the form-fitting section than for the conductor connection and the contact pin connection, so that the plug connector may also have a compact design. The form-fitting section may form, for example, a front side of the plug connector, which faces away from a conductor insertion side forming the back side of the plug connector and may be designed to be situated opposite the latter.

The form-fitting element may point in the direction of a base side of the second housing section, which faces the carrier structure, viewed in a mounting direction perpendicular to the mounting surface. A mechanical interaction of the form-fitting element with a mating form-fitting element arranged on a mounting surface of the carrier structure may be achieved hereby in an easy and intuitive manner. A defined alignment of the plug connector with the carrier structure and any contact pins arranged on the carrier structure is also possible, in particular, in the region of its contact pin insertion side. The form-fitting element may protrude toward the mounting surface of the carrier structure, viewed in the mounting direction. The form-fitting element may be designed, for example, to be brought into engagement with the mating form-fitting element by means of a movement of the plug connector on the mounting surface in parallel to the mounting surface. The base side of the plug connector may be assigned to a housing face of the insulating housing, which faces the carrier structure, in particular a mounting surface of the carrier structure, viewed in a mounting direction. A contact pin opening, for example, may be formed on the base side.

The form-fitting element may point in the direction of a front side of the second housing section, which faces away from the conductor insertion side. A mechanical interaction of the form-fitting element with a mating form-fitting element formed on an accessory part may be achieved hereby in an easy and intuitive manner. The accessory part may be connectable to the plug connector, for example, by joining the mating form-fitting element to the form-fitting element on the front side of the second housing section. The form-fitting element may be configured, for example, so that a mating form-fitting element of an accessory part may be brought into engagement with the form-fitting element in an insertion direction which runs in parallel to the contact pin insertion direction. The form-fitting element pointing toward the front side of the second housing section may have a vertical main extension in parallel to the contact pin insertion direction. The front side may be arranged opposite the conductor insertion side. The front side may run essentially in parallel to the conductor insertion side. The front side may be situated at a distance from the conductor insertion side by a total length of the insulating housing. The front side may run essentially perpendicularly to the contact pin insertion side.

The form-fitting element may be formed on an intermediate wall of the second housing extending in parallel to the front side of the second housing part. For example, accessory parts may be easily fastened on the plug connector hereby in a compact manner. The intermediate wall may be formed, for example, adjacent to a transitional region between the second housing section and the first housing section. The intermediate wall may be arranged between the front side and a back side having the conductor insertion opening and run in parallel thereto. The contact pin insertion opening of the plug connector may be arranged between the intermediate wall and the front side. If contact pins are inserted into the plug connector, they may extend between the intermediate wall and the front side essentially in parallel to the intermediate wall. According to one design possibility, an accessory part may be designed in such a way that it may simultaneously interact with a form-fitting element on the front side and with a form-fitting element on the intermediate wall with the aid of mating form-fitting elements situated at a distance from each other.

Multiple form-fitting elements may be formed on the second housing section. Individual or multiple form-fitting elements may advantageously be selected as needed hereby for connection to a mating form-fitting element of a mounting surface and/or of a connecting element. In addition, a connection security of the mechanical connection between the plug connector and the carrier structure may be increased by using multiple form-fitting elements for fixing the plug connector on the carrier structure. The multiple form-fitting elements may be provided with the same and/or different designs, for example, the same or different types of form-fitting contours. Different types of form-fitting contours may have, for example, different form-fitting geometries or be provided with different designs with respect to a positive or negative form-fitting contour. The form-fitting elements may be formed in the same or in different regions or on the same or different housing sides of the second housing section.

A first form-fitting element may point in the direction of the base side of the second housing section, a second form-fitting element may point in the direction of the front side of the second housing section, and/or a third form-fitting element may be formed on an intermediate wall of the second housing section. Multiple form-fit variants are made available hereby for establishing a connection between the plug connector and the carrier structure. For example, the form-fitting element pointing toward the base side may be configured for an interaction with a mating form-fitting element arranged on a mounting surface of the carrier structure, and the form-fitting element pointing toward the front side may be configured for an interaction with a mating form-fitting element formed on a connecting element, so that the plug connector is fixable on the carrier structure either directly on the mounting surface in a form-fitting manner or indirectly via a form-fitting connection to a connecting element which is connectable to the carrier structure. An increased mounting flexibility is achieved hereby, while the plug connector is easy to handle. An additional arrangement of accessory parts on the plug connector may be facilitated by the second form-fitting element and/or by a third form-fitting element on an intermediate wall of the second housing section extending in parallel to the front side.

The plug connector may be provided with a multipole design, and at least one form-fitting element per pole may be formed on the second housing section. Multipole plug connectors may have multiple contact inserts situated side by side, which may each have a connector terminal and a contact pin connection. Multiple connection possibilities for each plug connector may be provided hereby. The contact inserts may be arranged, for example, in connection compartments separated from each other by insulating walls or, if spaced a sufficient distance apart, at least in pairs in a shared connection compartment. A structural widening of the plug connector may go hand in hand with contact inserts arranged side by side, so that, depending on the number of poles, a secure and stable fixing of the plug connector to the carrier structure and/or a variable arrangement of an accessory part is/are made possible by multiple form-fitting elements on the second housing section. According to one design possibility, at least one form-fitting element per pole may be formed in each case on different housing sides of the second housing section, for example, a form-fitting element pointing toward the base side and the front side, so that an increased mounting flexibility is given.

The form-fitting element may have or form a form-fitting projection. A form-fitting projection may be a positive form-fitting contour, in which the form-fitting element represents a structure projecting with respect to an adjacent surface of the insulating housing. The form-fitting element may therefore form a local extension of the insulating housing in the second housing section. The form-fitting projection may be geometrically designed in such a way that an undercut having a form-fitting contour of the mating form-fitting element may be formed when the form-fitting element and the mating form-fitting element engage with each other. The form-fitting projection may be receivable in a receptacle of the mating form-fitting element.

The form-fitting element may have or form a form-fitting recess. A form-fitting recess may be a negative form-fitting contour, in which the form-fitting element represents a structure recessed with respect to an adjacent surface of the insulating housing. The form-fitting element may therefore form a local indentation of the insulating housing in the second housing section. The form-fitting recess may be geometrically designed in such a way that an undercut having a form-fitting contour of the mating form-fitting element may be formed when the form-fitting element and the mating form-fitting element engage with each other. The form-fitting recess may form a receptacle for the mating form-fitting element. Form-fitting projections and form-fitting recesses may be easily produced on an insulating housing. They may optionally be combined with each other on the second housing section for the purpose of increasing the mounting flexibility. They facilitate the establishment of a compact and effective form-fitting connection for fixing the plug connector directly and/or indirectly on the carrier structure. It is conceivable, in principle, that by arranging two form-fitting projections side by side, a form-fitting recess is formed therebetween. A form-fitting projection or a form-fitting recess may be optionally used for interacting with a mating form-fitting element.

The form-fitting element may have or form a dovetail contour or a receptacle for a mating form-fitting element having a dovetail contour. An easy, intuitive, effective, and secure establishment of a form-fitting interaction between the form-fitting element and a correspondingly shaped mating form-fitting element is made possible hereby. For example, the form-fitting element may have a dovetail contour, and the mating form-fitting element may have a receptacle which has a negative contour corresponding to the dovetail contour of the form-fitting element. Alternatively, the form-fitting element may have a corresponding negative contour as a receptacle for a mating form-fitting element having a dovetail contour. A dovetail contour may have at least one sloping face, which may be supported on a corresponding mating sloping face of the negative contour and form an undercut therewith.

The form-fitting element may have or form a T contour or a receptacle for a mating form-fitting element having a T contour. An easy, intuitive, effective, and secure establishment of a form-fitting interaction between the form-fitting element and a correspondingly shaped mating form-fitting element is possible hereby. For example, the form-fitting element may have a T contour, and the mating form-fitting element may have a receptacle which has a negative contour corresponding to the T contour of the form-fitting element. Alternatively, the form-fitting element may have a corresponding negative contour as a receptacle for a mating form-fitting element having a T contour. A T contour may have a transverse web protruding from both sides of a longitudinal web, which may be supported on a corresponding mating face of the negative contour and form an undercut therewith.

The form-fitting element may have or form an L contour or a receptacle for a mating form-fitting element having an L contour. An easy, intuitive, effective, and secure establishment of a form-fitting interaction between the form-fitting element and a correspondingly shaped mating form-fitting element is made possible hereby. For example, the form-fitting element may have an L contour, and the mating form-fitting element may have a receptacle which has a negative contour corresponding to the L contour of the form-fitting element. Alternatively, the form-fitting element may have a corresponding negative contour as a receptacle for a mating form-fitting element having an L contour. An L contour may have a transverse web protruding from one side of a longitudinal web, which may be supported on a corresponding mating face of the negative contour and form an undercut therewith. In principle, not only a T-shaped form-fitting element but also an L-shaped form-fitting element may be received by a T-shaped negative contour, so that an increased flexibility is associated with a form-fitting contour of this type.

At least one form-fitting element pointing toward the front side may be formed on the second housing section, which has or forms a form-fitting recess for a mating form-fitting element, and at least one form-fitting element pointing toward the base side may be formed on the second housing section, which has or forms a form-fitting recess for a mating form-fitting element. A versatile combination of form-fitting elements on the second housing section is given hereby, which may be optionally used to fasten the plug connector on the carrier structure. The form-fitting element pointing toward the front side or the base side may have or form, for example, a receptacle for a mating form-fitting element having a dovetail contour, a T contour, or an L contour. According to alternative design possibilities, the two form-fitting elements may be designed as form-fitting projections, or one form-fitting element may be designed as a form-fitting projection and the other form-fitting element may be designed as a form-fitting recess.

A form-fitting element may be formed on the second housing section, which is configured for an interaction with a mating form-fitting element formed on a connecting pin. An easy, intuitive, and compact fastening possibility for fixing the plug connector on the carrier structure is given hereby. The connecting pin may form a connecting element for fixing the plug connector on the carrier structure. The connecting pin may have an elongated bar shape. The connecting pin may form an accessory part of the electrical plug connector. The connecting pin may have a fastening section for fastening on the carrier structure, a shaft, and the mating form-fitting element. The mating form-fitting element may be designed, for example, to be integral with the shaft of the connecting pin. The fastening section may have, for example, an elastically deformable latching edge, which may be inserted through a latching opening of the carrier structure and be latched thereto. The form-fitting element of the second housing section may have a design adapted to the mating form-fitting element of the connecting pin with respect to its geometry and dimensioning, and it may thereby be configured to receive a connecting pin of this type in a form-fitting manner.

The plug connector may be configured to be fixed on a mounting surface of a printed circuit board. This enables the plug connector to be advantageously used as a printed circuit board plug connector, by which means the range of applications of the plug connector is expanded. The plug connector may have, for example, a dimensioning suitable for a printed circuit board. The plug connector may have, for example, a conductor connection with a conductor insertion direction which runs in parallel to the mounting surface of the printed circuit board. The form-fitting element of the second housing section of the plug connector may be suitable for fixing the plug connector directly on the mounting surface of the printed circuit board in a form-fitting manner and/or for fixing the plug connector indirectly on the mounting surface of the printed circuit board via a connecting element. The mounting surface of the printed circuit board may have, for example, a mating form-fitting element which is compatible with the form-fitting element of the plug connector. The mounting surface of the printed circuit board may have, for example, a fastening element, for example a printed circuit board opening, with the aid of which a connecting element connected to the plug connector in a form-fitting manner, for example a connecting pin, may be securely fixed on the mounting surface. At least one contact pin, in particular a contact pin strip, may be arranged on the mounting surface of the printed circuit board. The plug connector may be configured to be mounted on the mounting surface of the printed circuit board in such a way that the contact pin or multiple contact pins, for example multiple contact pins of the contact pin strip, may be joined to one or multiple contact pin connection(s) of the plug connector. In particular, the plug connector may be able to be arranged and fixed on the mounting surface in such a way that the contact pin or the contact pins is/are automatically insertable into suitable contact pin insertion openings arranged on the plug connector.

The form-fitting element may be configured for an interaction with a mating form-fitting element of an accessory part of the plug connector. An optional expansion of the functions of the plug connector and/or an optional indirect connection of the plug connector to the carrier structure via a connecting element provided as an accessory part is/are made possible hereby. An easy handling of the plug connector and increased user comfort may be achieved by the form-fitting connectability of the plug connector to an accessory part. The accessory part of the plug connector may be, for example, a constituent part of a set having a plug connector, which is described below. The accessory part may be viewed as a component which is separate from the carrier structure and the plug connector. Due to the form-fitting connection between the plug connector and the accessory part, the latter may be detachable from the plug connector, in particular in a non-destructible manner, so that an increased flexibility exists with respect to the arrangement and removal of accessory parts of the plug connector.

The accessory part may be designed as a connecting element, bridging element, or contact protection element. Due to the connecting pin, the plug connector may be indirectly connectable to the carrier structure. Two or more poles of the plug connector may be electrically connected to each other by means of a bridging element. The plug connector may have, for example, one form-fitting element per pole, so that the bridging element may be securely and easily arranged in a selected position on the poles to be bridged. An operational safety of the plug connector may be increased by means of a contact protection element. The contact protection element may be designed, for example, as a shield or cap. The contact protection element may correspond to a pitch distance of the plug connector in terms of its width for the purpose of being able to arrange it individually per pole. Alternatively, the contact protection element may be configured to be arranged on the plug connector across poles. For example, individual or multiple contact pins inserted into the plug connector may be able to be covered or concealed by means of the contact protection element, so that the contact protection may effectuate, in particular, a barrier to prevent a contact with a contact pin.

The insulating housing may have a fastening securing section for mechanically securing the plug connector on the carrier structure. A direct or indirect form-fitting connection of the plug connector to the carrier structure may be advantageously supported and secured hereby. The mechanical securing may form an additional fastening possibility, which goes beyond the form-fitting fixing of the plug connector on the carrier structure. The fastening securing section may be able to be screwed, for example, to a mounting surface of the carrier structure. The fastening securing section may therefore be configured to form a screw connection with the carrier structure and have, for example, a screw opening for this purpose, which may be arranged, for example, in a fastening flange of the insulating housing. Alternatively or additionally, the fastening securing section may be configured to form a latching connection to the carrier structure and have, for example, a latching structure for this purpose to latch the plug connector to a corresponding mating latching structure on the carrier structure. Alternatively or additionally, the fastening securing section may be configured to form a further form-fitting connection to the carrier structure and have, for example, a further form-fitting structure for this purpose to interact with a further mating form-fitting structure of the carrier structure.

The fastening securing structure may be formed on the second housing section. This enables a connection security between the plug connector and the carrier structure to be increased locally in a targeted manner. By forming the fastening securing section on the second housing section, it is provided close to the form-fitting indirect or direct connection to the carrier structure for a high effectiveness. The fastening securing section may be formed, for example, on the base side, the front side, and/or on a side surface of the second housing section extending essentially perpendicularly to the base side and the front side.

The fastening securing section can be formed on the first housing section. A uniform introduction of force into the insulating housing and a secure, stable fixing of the plug connector on the carrier structure may be ensured hereby. The fastening securing section may be formed, for example, on a base side, a back side facing the conductor insertion opening, and/or on a side face of the first housing section extending essentially perpendicularly to the back side and the base side.

The conductor connection may be designed as a spring-force clamping connection. A particularly comfortable and secure connection of flexible electrical conductors to the conductor connection is made possible hereby. A spring-force clamping connection may have a clamping spring, which is arranged in the region of a busbar of the contact insert of the plug connector in such a way that an electrical conductor may be clamped between a clamping leg of the clamping spring and the busbar. The plug connector may optionally have an actuating element assigned to the conductor connection, which is configured to open and/or close a clamping point between the clamping spring and the busbar.

The object is also achieved by a set having an electrical plug connector according to one of the features described above and having an accessory part, which includes a mating form-fitting element suitable for interaction with the form-fitting element of the second housing section of the electrical plug connector. The proposed set makes an optional expansion of the functions of the plug connector and/or an optional indirect connection of the plug connector to the carrier structure possible, using a connecting element provided as an accessory part, so that a high operational flexibility and variety of functions are achieved with a compact design of the electrical plug connector. The set may have multiple accessory parts of the same type and/or of different types. For example, the set may have at least one connecting element per pole of the plug connector. For example, the set may have a connecting element, a bridging element, and/or a contact protection element in addition to the plug connector. According to one design possibility, an accessory part may be designed in such a way that it may simultaneously interact with a form-fitting element on the front side and with a form-fitting element on the intermediate wall of the second housing section with the aid of mating form-fitting elements situated at a distance from each other.

The accessory part may be designed as a connecting element for fixing the plug connector on the carrier structure. An indirect connection of the plug connector to the mounting surface may be established hereby as an alternative or addition to a direct connection of the plug connector to the mounting surface. The connecting element may be designed, for example, as a connecting pin. The mating form-fitting element of the connecting element may be designed, for example, as a form-fitting projection and have or form, in particular, a dovetail contour, a T contour, or an L contour.

The accessory part may be designed as a bridging element. Two or more poles of the plug connector may be electrically connected to each other hereby. The plug connector may have, for example, one form-fitting element per pole, so that the bridging element may be securely and easily arranged in a selected position on the poles to be bridged. The mating form-fitting element of the bridging element may be designed, for example, as a form-fitting projection and have or form, in particular, a dovetail contour, a T contour, or an L contour.

The accessory part may be designed as a contact protection element. An operational safety of the plug connector may be increased by means of a contact protection element. The contact protection element may be designed, for example, as a shield or cap. For example, contact pins inserted into the plug connector may be able to be covered or concealed by means of the contact protection element, so that the contact protection may effectuate, in particular, a barrier to prevent a contact with a contact pin. The mating form-fitting element of the contact protection element may be designed, for example, as a form-fitting projection and have or form, in particular, a dovetail contour, a T contour, or an L contour.

The set may additionally have a contact pin strip. Multiple contact pins may be advantageously provided hereby in a defined arrangement and orientation in relation to each other to provide a connection to the contact pin connections of the plug connector. A contact pin strip may be an elongated carrier having multiple contact pins arranged next to each other. The contact pin strip may be configured to be fixed on a mounting surface of the carrier structure. The contact pin strip may have a fastening element for this purpose. The contact pin strip may be configured, in particular, to be arranged on a mounting surface of a printed circuit board. The plug connector may be able to be arranged and fixed on the mounting surface in such a way that the contact pins of the contact pin strip are automatically insertable into matching contact pin insertion openings arranged on the plug connector. The contact pin strip may be adapted to the plug connector in terms of a geometric shape and dimensioning, for example, it may have a contact pin spacing which corresponds to the distances between the contact pin insertion openings of the second housing section.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a schematically shows an electrical plug connector positioned on a mounting surface according to an example, in a perspective front view in a state not connected in a form-fitting manner to the mounting surface;

FIG. 1b schematically shows the plug connector illustrated in FIG. 1a in a perspective front view in a state connected in a form-fitting manner to the mounting surface;

FIG. 2a schematically shows the electrical plug connector according to the example and connecting elements connected in a form-fitting manner to the plug connector, in a perspective front view in a state not connected to the mounting surface;

FIG. 2b schematically shows the plug connector illustrated in FIG. 2a in a perspective front view in a state connected to the mounting surface;

FIG. 2c schematically shows the plug connector illustrated in FIG. 2b in a side view in a state connected to the mounting surface;

FIG. 3a schematically shows the electrical plug connector according to the example and a bridging element connected in a form-fitting manner to the plug connector, in a perspective front view;

FIG. 3b schematically shows the plug connector illustrated in FIG. 3a in a cutaway front view;

FIG. 4a schematically shows the electrical plug connector according to the example in a perspective side view without a contact protection element;

FIG. 4b schematically shows the plug connector illustrated in FIG. 4a and contact protection elements connected in a form-fitting manner to the plug connector;

FIG. 5a schematically shows the electrical plug connector according to the example having a fastening securing section, in a perspective side view in a non-secured state;

FIG. 5b schematically shows the electrical plug connector illustrated in FIG. 5a having a fastening securing section, in a perspective side view in a secured state;

FIG. 6a schematically shows an electrical plug connector having a contact pin insertion side on the housing upper side and a contact protection cap; and

FIG. 6b schematically shows the electrical plug connector from FIG. 6a, including a printed circuit board mounted from above.

### DETAILED DESCRIPTION

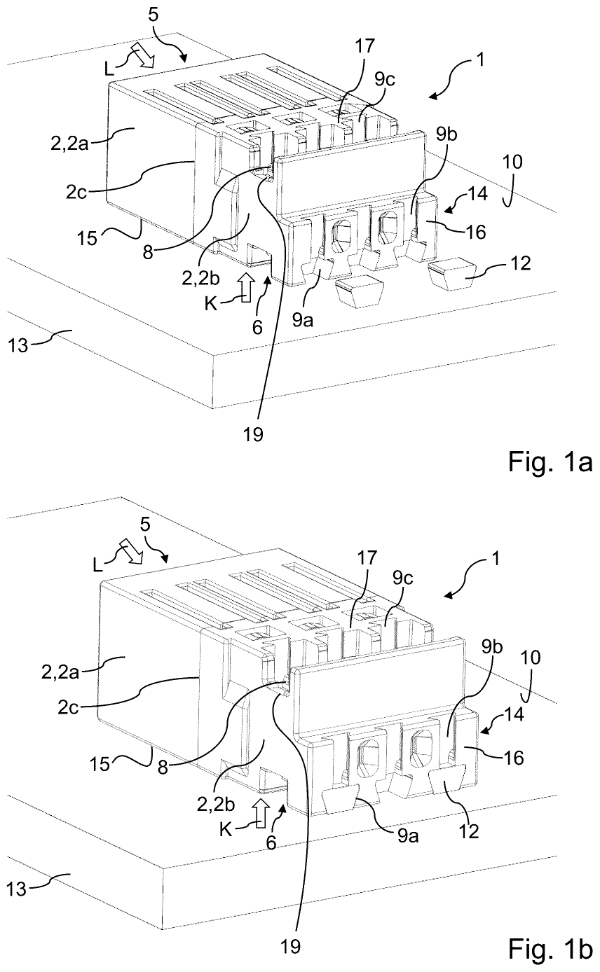

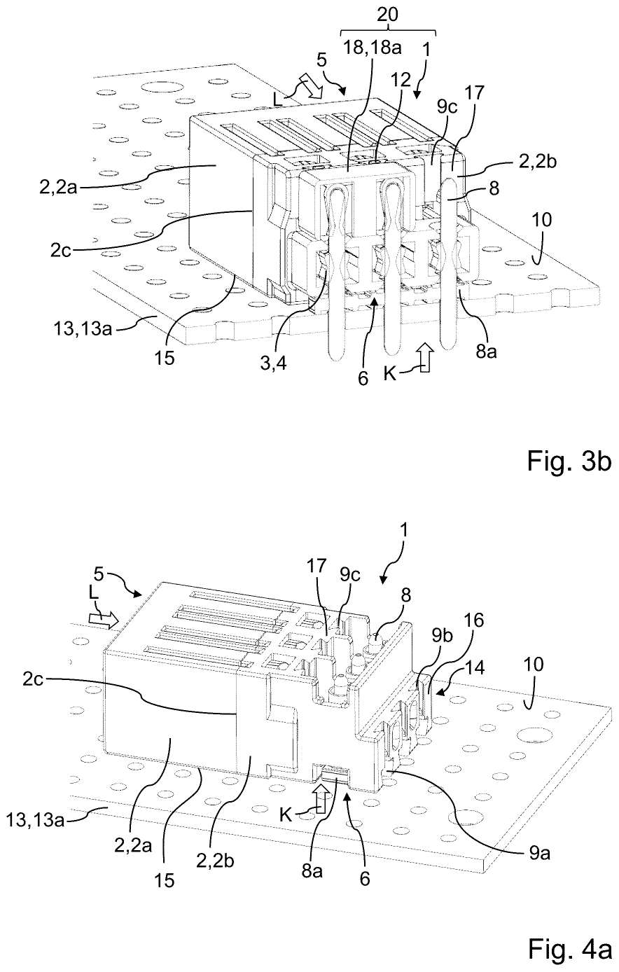

FIGS. 1a and 1b show an electrical plug connector 1 according to an example, which is positioned on a mounting surface 10 of a carrier structure 13 designed as a mounting plate. Electrical plug connector 1 has an insulating housing 2 with a first housing section 2a and a second housing section 2b. Multiple, more precisely three, contact insertions 3 are received in insulating housing 2. which are partially illustrated in FIG. 3b. Accordingly, plug connector 1 is designed as a multipole plug connector 1 and has three poles. Contact inserts 3 each have a busbar, a conductor connection arranged in first housing section 2a for connecting electrical conductors, and a contact pin connection 4 arranged in second housing section 2b, which is indicatively illustrated in FIG. 3b, for connecting rigid conductors in the form of contact pins 8 illustrated, for example, in FIGS. 3a and 3b. The conductor connection may be designed, in particular, as a spring-force clamping connection. For this purpose, a clamping spring may be arranged on the busbar, with the aid of which an, in particular flexible, conductor may be clamped between the clamping spring and the busbar.

It is apparent that first housing section 2a includes a fastening structure, which has a fastening securing section 19 for mechanically securing the plug connector on carrier structure 13, for example in the form of a latching edge. This mechanical securing forms an additional fastening possibility which goes beyond the form-fitting fixing of plug connector 1 on carrier structure 13.

In the illustrated example, fastening securing section 19 is configured to form a further form-fitting connection to the carrier structure 13. Carrier structure 13 may have a further form-fitting structure for latching to fastening section 19.

Insulating housing 2 has a conductor insertion side 5 in first housing section 2a, including conductor insertion openings for inserting electrical conductors. The conductor connections of contact inserts 3 are configured to connect the electrical conductors. These are insertable into plug connector 1 in a conductor insertion direction. Second housing section 2b is arranged on a plug connector side situated opposite conductor insertion side 5, so that a defined spatial separation of a conductor connection function and a contact pin connection function of plug connector 1 is present. Second housing section 2b has a contact pin insertion side 6 with contact insertion openings 7 for inserting, for example, contact pins 8 illustrated in FIGS. 3a and 3b, which are arranged on a contact pin strip 8a. Contact pin strip 8a may be fixed on mounting surface 10. Contact pin connections 4 are configured to connect contact pins 8. As indicated in FIGS. 3a and 3b, they may be designed as socket contacts having two elastically deflectable socket arms, which extend in parallel to each other. Contact pins 8 are insertable into plug connector 1 in a contact pin insertion direction K. Conductor insertion direction L and contact insertion direction K run essentially perpendicularly to each other, so that flexible electrical conductors and contact pins 8 are insertable into plug connector 1 from different spatial directions. Conductor insertion side 5 and contact pin insertion side 6 also extend in housing planes arranged essentially perpendicularly to each other, which makes it possible to more easily establish an electrical connection to plug connector 1.

Contact pin insertion side 6 may open onto the housing upper side situated opposite carrier structure 13 to insert contact pins into contact pin connections 4 from the housing upper side. This construction is advantageous, for example, if carrier structure 13 is, for example, a housing wall or cover wall, and this arrangement made up of the cover and plug connector is mounted onto a contact pin arrangement protruding from a printed circuit board.

First housing section 2a and second housing section 2b are designed as separate housing components and are connected to each other. First housing section 2a and second housing section 2b transition into each other along a separation plane 2c. First housing part 2a may form a main housing part, and second housing part 2b may form a cover part, with the aid of which the main housing part may be closed. An easy manufacturing of plug connector 1 is ensured hereby, since contact inserts 3 may be easily inserted into insulating housing 2 before the latter is closed. First housing section 2a and second housing section 2b may be connected to each other, for example via a form-fitting and/or force-fitting connection, for example a latching connection.

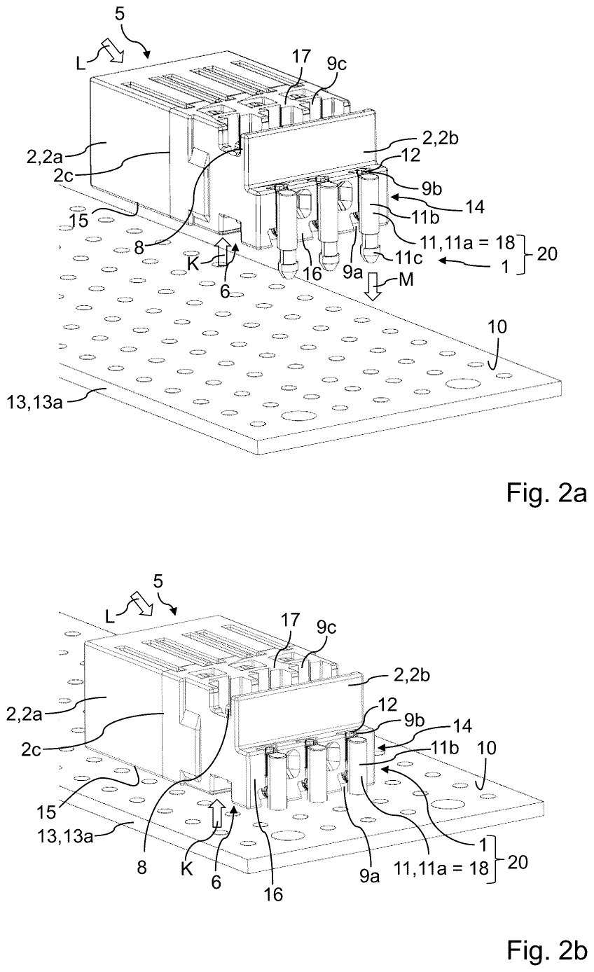

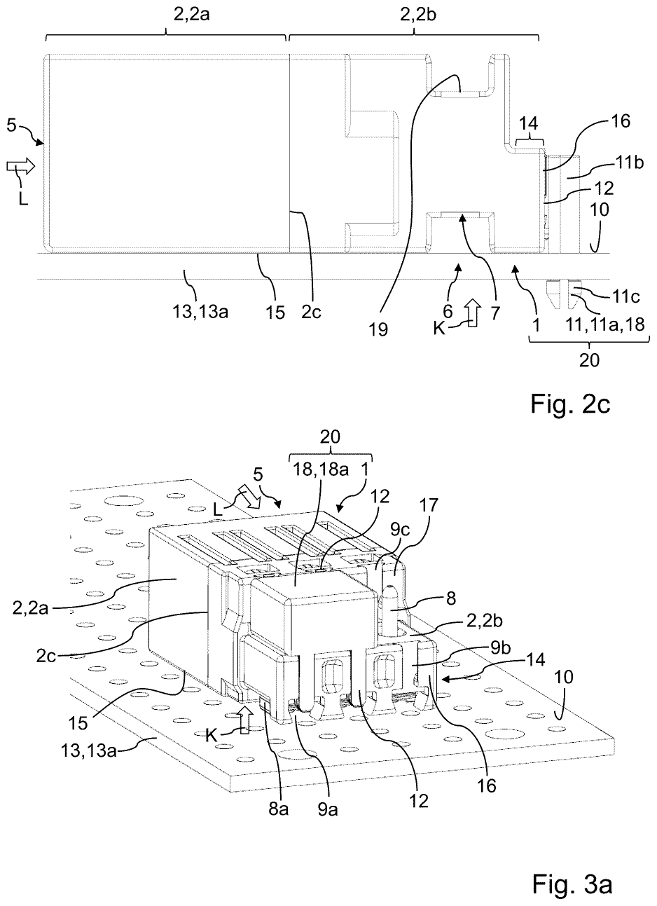

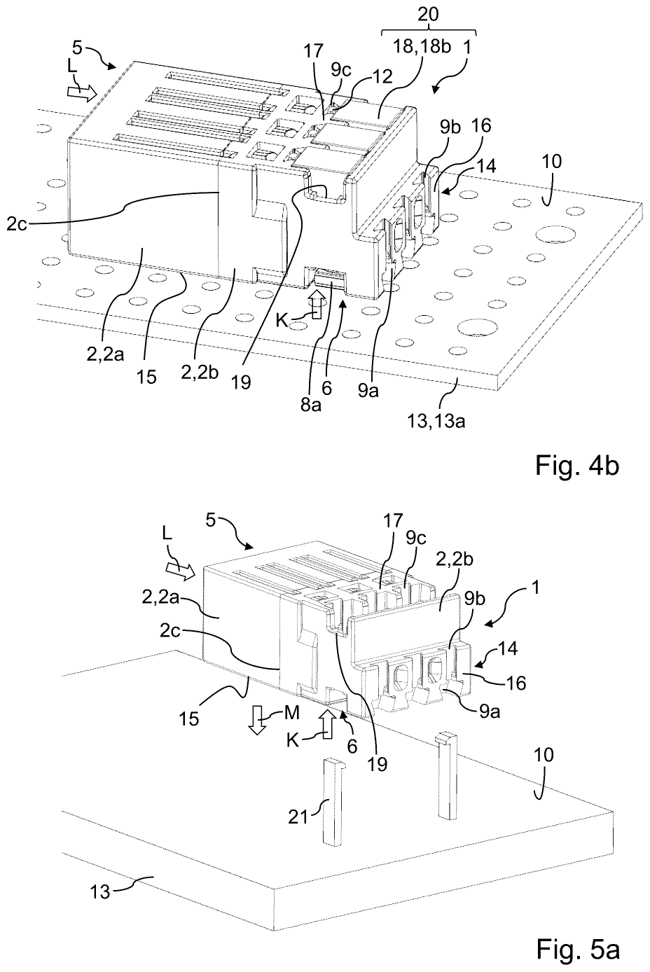

Multiple, more specifically three, first form-fitting elements 9a, second form-fitting elements 9b, and third form-fitting elements 9c designed to be integral with insulating housing 2 are formed on second housing section 2b. First form-fitting elements 9a are configured for an interaction with mating form-fitting elements 12 arranged on mounting surface 10 for the purpose of fixing plug connector 1 on carrier structure 13. Second form-fitting elements 9b are configured for an interaction with mating form-fitting elements 12 of connecting elements 11 illustrated in FIGS. 2a and 2b for the purpose of fixing plug connector 1 on carrier structure 13. Third form-fitting elements 9c are configured for an interaction with mating form-fitting elements 12 of an accessory part 18 designed as a bridging element 18a and illustrated, for example, in FIGS. 3a and 3b, as well as for an interaction with mating form-fitting elements 12 of an accessory part 18 designed as a contact protection element 18b illustrated, for example, in FIG. 4b. Due to first, second, and third form-fitting elements 9a, 9b, 9c, it is possible, on the one hand, to fix plug connector 1 on mounting surface 10 in a flexible and secure manner and, on the other hand, to optionally add to a range of functions of plug connector 1 by means of accessory parts 18 connectable to plug connector 1. A compact, easy-to-mount and easy-to-handle plug connector 1 is thus provided, which has an optionally expandable functionality for different installation requirements. By forming first form-fitting elements 9a and second form-fitting elements 9b in second housing section 2b, contact pin connections 4 of plug connector 1 may be precisely aligned with contact pin strip 8a fixed on mounting surface 10 and illustrated in FIGS. 3a and 3b. The form-fitting connection may be establishes directly to a mating form-fitting element 12 of mounting surface 10 or indirectly to mating form-fitting elements 12 via connecting elements 11 in an easy manner, in particular, without tools. By forming third form-fitting element 9c in second housing section 2b, accessory parts 18 may be advantageously used, which have a function relating to contact pins 8 receivable in second housing section 2b, for example, preventing a contact with contact pins 8 in the form of a contact protection element 18b or permitting an electrical bridging between contact pins 8 in the form of a bridging element 18a.

As is apparent, for example, in FIGS. 1a and 1b, second housing section 2b has a stepped form-fitting section 14 arranged on second housing section 2b, which is offset in a stepped manner from the adjacent contour of second housing section 2b, and in which first form-fitting elements 9a and second form-fitting elements 9b are formed, so that a defined connecting region is made available on second housing section 2b. Form-fitting section 14 may have a lower installation height, as illustrated, than other regions of second housing section 2b to obtain a compact plug connector 1.

First form-fitting elements 9a point in the direction of a base side 15 of second housing section 2b, so that they may be brought into engagement with mating form-fitting elements 12 on mounting surface 10. Base side 15 is a housing side of plug connector 1 which faces carrier structure 13, viewed in a mounting direction M, as indicated, for example, in FIG. 2a. As is apparent, for example, in FIGS. 1a and 1b, first form-fitting elements 9a are designed as form-fitting recesses and thus have a negative form-fitting contour. They each form a receptacle for a mating form-fitting element 12 arranged on mounting surface 10, which has a dovetail contour, which makes an easy and secure establishment of a form-fitting connection possible. Form-fitting elements 9a and mating form-fitting elements 12 are illustrated in FIG. 1a in a state situated at a distance from each other. FIG. 1b shows that form-fitting elements 9a and mating form-fitting elements 12 are connected to each other in a form-fitting manner. For this purpose, for example, a movement of plug connector 1 along mounting surface 10 in a direction in parallel to mounting surface 10 may take place, in which form-fitting elements 9a and mating form-fitting elements 12 are guided to each other and brought into engagement with each other. Due to the special shaping, the housing regions adjacent to the form-fitting recesses may also be viewed as form-fitting projections.

Second form-fitting elements 9b point in the direction of a front side 16 of second housing section 2b, which faces away from conductor insertion side 5, so that they may be brought into engagement with mating form-fitting elements 12 on connecting elements 11, as illustrated in FIGS. 2a and 2b, or into engagement with mating form-fitting elements 12 of an accessory part 18, as illustrated in FIG. 3a. Second form-fitting elements 9b may have an essentially vertical extension in parallel to contact pin insertion direction K, as indicated in FIGS. 1a and 1b. As is apparent, for example, in FIGS. 1a and 1b, second form-fitting elements 9b are designed as form-fitting recesses and thus have a negative form-fitting contour. They each form a receptacle for a mating form-fitting element 12 formed on a connecting element 11 and having a dovetail contour, which makes an easy and secure establishment of a form-fitting connection possible, as indicated schematically, for example, in FIGS. 2a and 2b.

Third form-fitting elements 9c are formed on an intermediate wall 17 of second housing section 2b, which extends in parallel to front side 16 of second housing section 2b, so that they may be brought into engagement with mating form-fitting elements 12 of an accessory part 18, as illustrated in FIGS. 3a, 3b, and 4b. Intermediate wall 17 may run, as illustrated, between front side 16 and conductor insertion side 5, in particular, essentially in parallel to separation plane 2c. As is apparent, for example, in FIGS. 1a and 1b, third form-fitting elements 9c are designed as form-fitting recesses and thus have a negative form-fitting contour. They each form a receptacle for a mating form-fitting element 12 arranged on an accessory part 18 and having a dovetail contour, which makes an easy and secure establishment of a form-fitting connection possible, as indicated schematically in FIGS. 3a, 3b, and 4b.

Alternatively or in addition to form-fitting elements 9a, 9b, 9c or mating form-fitting elements 12 having a dovetail contour, L contours or T contours may also be used, with the aid of which an easy and secure establishment of a form-fitting connection is likewise possible.

In connection with the multi-pole design of plug connector 1, a first form-fitting element 9a, a second form-fitting element 9b, and a third form-fitting element 9c may be formed for each pole on second housing section 2b. This makes it possible to ensure that a secure and stable fixing of plug connector 1 on mounting surface 10 of carrier structure 13 is achievable with multiple connection possibilities for each plug connector 1. A variable arrangement of accessory parts 18 on plug connector 1 is also made possible.

FIGS. 2a through 2c show electrical plug connector 1 according to the example as well as connecting elements 11 connected in a form-fitting manner to plug connector 1. Connecting elements 11 represent components separate from plug connector 1 and may be made available, for example, as accessory parts 18 and connected to plug connector 1. With the aid of mating form-fitting elements 12 formed on connecting elements 11, which interact with second form-fitting elements 9b and may form a form-fitting connection, plug connector 1 may be indirectly fixed on mounting surface 10 of carrier structure 13, which is designed in this example as a printed circuit board 13a. According to the illustrated example, connecting elements 11 are designed as connecting pins 11a. Connecting pins 11a each have a shaft 11b, on which a mating form-fitting element 12 is arranged, in particular, designed to be integral with shaft 11b. Connecting elements 11a each have a fastening element 11c, which is designed as an elastically deformable latching element and is able to be guided through a printed circuit board opening of printed circuit board 13a and may be latched thereon. FIG. 2a shows how plug connector 1 may be guided onto mounting surface 10 in mounting direction M. FIGS. 2b and 2c show that plug connector 1 is securely fixed on carrier structure 13 via connecting elements 11, in that their fastening elements 11c engage through a particular printed circuit board opening and latch on an opening edge of the printed circuit board opening.

FIGS. 3a and 3b show electrical plug connector 1 according to the example and a bridging element 18a, which is connected in a form-fitting manner to plug connector 1 and represents an accessory part 18 of plug connector 1. Two or more poles of plug connector 1 may be electrically connected to each other with the aid of bridging element 18a. FIG. 3a shows a perspective front view, which clarifies the anchoring of mating form-fitting elements 12 in second form-fitting elements 9b, while FIG. 3b illustrated the bridging function of bridging element 18a in a sectional view.

FIGS. 4a and 4b show electrical plug connector 1 without a contact protection according to the example in FIG. 4a and contact protection elements 18b connected in a form-fitting manner to plug connector 1 in FIG. 4b, which represent accessory parts 18 of plug connector 1. An operational safety of plug connector 1 may be increased with the aid of a contact protection element 18b, which represents a cap for covering contact pin 8. According to the example, one contact protection element 18b is provided for each contact pin 8.

According to the example illustrated in FIGS. 2a through 2c, 3a and 3b, as well as 4a and 4b, carrier structure 13 is designed as a printed circuit board 13a, and mounting surface 10 of carrier structure 13 is designed as a printed circuit board surface of printed circuit board 13a, so that plug connector 1 is designed as a printed circuit board plug connector.

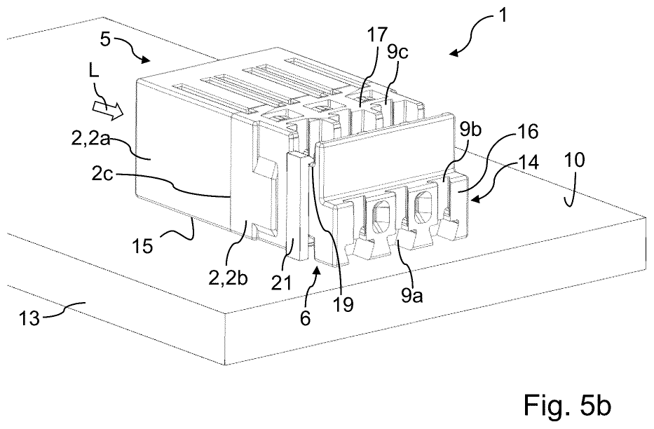

FIGS. 5a and 5b show electrical plug connector 1 according to the example having a fastening securing section 19, in a perspective side view, in a non-secured state in FIG. 5a and in a secured state in FIG. 5b. According to the illustrated example, fastening securing section 19 is formed on second housing section 2b. Fastening securing section 19 is used for a mechanical securing for the purpose of an additional fixing of plug connector 1 on carrier structure 13. According to the example illustrated in FIG. 5a an 5b, a latching structure designed as a latching edge is provided in fastening securing section 19 on second housing section 2b, which is suitable for establishing a latching connection to a mating latching structure 21 designed as a latching arm on carrier structure 13. The latching arm has a latching tab on its movable free end, which forms a form fit with fastening securing section 19 in the latched state. For this purpose, the latching tab engages over a latching edge limited by walls on the side.

A set 20 having an electrical plug connector 1 and at least one accessory part 18 is furthermore apparent from FIGS. 2a through 2c, 3a and 3b, as well as 4b. Accessory part 18 or accessories parts 18 has/have in each case at least one mating form-fitting element 12 for interaction with second form-fitting elements 9b and/or with third form-fitting element 9c of second housing section 2b. In FIGS. 2a through 2c, accessory parts 18 are designed as connecting elements 11, specifically as connecting pins 11a. In FIGS. 3a and 3b, accessory part 18 is designed as a bridging element 18a. In FIG. 4b, accessory parts 18 are designed as contact protection elements 18b. Set 20 may also have different accessory parts 18; for example, connecting pins 11 may be combined with one or multiple bridging elements 18a or with contact protection elements 18b. Moreover, set 20 may have a contact pin strip 8a, as illustrated, for example, in FIGS. 3a and 3b.

A set 20 having an electrical plug connector 1 and at least one accessory part 18 makes an optional expansion of the functions of plug connector 1 and/or an optional indirect connection of plug connector 1 to carrier structure 13 possible, using a connecting element 11 provided as an accessory part 18, so that a high operational flexibility and variety of functions are achieved with a compact design of electrical plug connector 1.

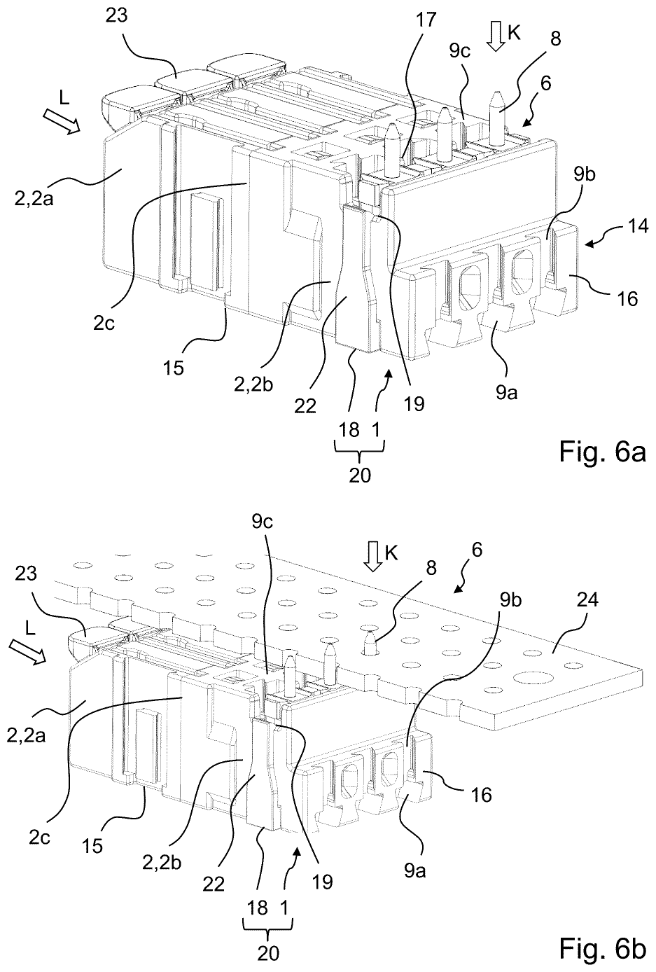

FIGS. 6a and 6b show an electrical plug connector 1, which has, in principle, the design illustrated in FIGS. 1a through 5b described above. Contact pin connections 4 are open in the direction of the housing upper side of insulating housing 2, which is situated opposite base side 15 for resting upon a carrier structure 13, so that inserted contact pins 8 protrude upwardly away from base side 15.

It is apparent from FIG. 6b that a printed circuit board 24 may be positioned onto the housing upper side of insulating housing 2 from above. Contact pins 8 may be soldered onto printed circuit board 24 and protrude from the plane of printed circuit board 24. Plug connector 1 is then placed onto printed circuit board 24 together with its contact pin connection 4, and contact pins 8 are inserted into contact pin connections 4. Plug connector 1 may also be placed with base side 15 onto a carrier structure 13 and be connected thereto.

An accessory part 18, for example in the form of a bridging element 18a or contact protection element 18b, may then be inserted from base side 15 into insulating housing 2 in the region of contact pin connection 4. Contact pins 8 may be connected thereby to each other in an electrically conductive manner and be bridged thereby, and/or contact pins 8 may be shielded to the outside by insulating material of bridging element 18a or contact protection element 18b and be protected against being touched. Bridging element 18a or contact protection element 18b may have retaining arms 22, which protrude along the side of insulating housing 2 and are latched to fastening securing section 19. Accessory part 18 may be designed as a contact protection cap, which extends over the width of insulating housing 2 and has two opposite retaining arms 22, which may be latched on insulating housing 2 in directions of force facing each other.

The electrical plug connector may have actuating elements 23 on conductor insertion side 5, which each interact with a spring-force clamping connection arranged in the insulating housing for clamping an electrical conductor to open the spring-force clamping connection for the purpose of inserting or removing an electrical conductor. Actuating elements 23 may be designed as actuating levers, as illustrated, or as actuating pushbuttons and the like. Actuating levers 23 of this type may likewise also be present on plug connectors 1 of the other examples described above.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electrical plug connector comprising:
an insulating housing with a first housing section and a second housing section;
a contact insert arranged at the insulating housing, the contact insert having a conductor connection arranged in the first housing section and a contact pin connection arranged in the second housing section,
a conductor insertion side provided for the insulating housing, the conductor insertion side, in the first housing section, being provided with a conductor insertion opening for inserting an electrical conductor and having a contact pin insertion side, in the second housing section, being provided with a contact pin insertion opening for inserting a contact pin; and
a form-fitting element formed on the second housing section, which is configured for an interaction with a mating form-fitting element formed on a mounting surface and/or on a connecting element to fix the plug connector on a carrier structure.

2. The electrical plug connector according to claim 1, wherein the conductor connection is configured for connecting an electrical conductor, which is insertable into the plug connector in a conductor insertion direction, and wherein the contact pin connection is configured for connecting a contact pin, which is inserted into the plug connector in a contact pin insertion direction, and wherein the conductor insertion direction and the contact pin insertion direction run essentially perpendicularly to each other.

3. The electrical plug connector according to claim 1, wherein the conductor insertion side and the contact pin insertion side extend in housing planes arranged essentially in parallel to each other.

4. The electrical plug connector according to claim 1, wherein the second housing section is arranged on a plug connector side situated opposite the conductor insertion side.

5. The electrical plug connector according to claim 1, wherein the first housing section and the second housing section are designed as separate housing components and are connected to each other.

6. The electrical plug connector according to claim 1, wherein the second housing section has a form-fitting section offset in a stepped manner from the second housing section, in which at least one form-fitting element of the second housing section is formed.

7. The electrical plug connector according to claim 1, wherein the form-fitting element points in the direction of a base side of the second housing section, which faces the carrier structure, viewed in a mounting direction.

8. The electrical plug connector according to claim 1, wherein the form-fitting element points in the direction of a front side of the second housing section, which faces away from the conductor insertion side.

9. The electrical plug connector according to claim 1, wherein the form-fitting element is formed on an intermediate wall of the second housing section, which extends in parallel to the front side of the second housing section.

10. The electrical plug connector according to claim 1, wherein multiple form-fitting elements are formed on the second housing section.

11. The electrical plug connector according to claim 10, wherein a first form-fitting element points in the direction of the base side of the second housing section, wherein a second form-fitting element points in the direction of the front side of the second housing section, and/or wherein a third form-fitting element is formed on an intermediate wall of the second housing section.

12. The electrical plug connector according to claim 10, wherein the plug connector has a multipole design, and wherein at least one form-fitting element for each pole is formed in the second housing section.

13. The electrical plug connector according to claim 1, wherein the form-fitting element has or forms a form-fitting projection.

14. The electrical plug connector according to claim 1, wherein the form-fitting element has or forms a form-fitting recess.

15. The electrical plug connector according to claim 1, wherein the form-fitting element has or forms a dovetail contour or a receptacle for a mating form-fitting element having a dovetail contour.

16. The electrical plug connector according to claim 1, wherein the form-fitting element has or forms a T contour or a receptacle for a mating form-fitting element having a T contour.

17. The electrical plug connector according to claim 1, wherein the form-fitting element has or forms an L contour or a receptacle for a mating form-fitting element having an L contour.

18. The electrical plug connector according to claim 1, wherein at least one form-fitting element pointing toward the front side is formed on the second housing section, which has or forms a form-fitting recess for a mating form-fitting element, and at least one form-fitting element pointing toward the base side is formed on the second housing section, which has or forms a form-fitting recess for a mating form-fitting element.

19. The electrical plug connector according to claim 1, wherein a form-fitting element is formed on the second housing section, which is configured for an interaction with a mating form-fitting element formed on a connecting pin.

20. The electrical plug connector according to claim 1, wherein the plug connector is configured to be fixed on a mounting surface of a printed circuit board.

21. The electrical plug connector according to claim 1, wherein the form-fitting element is configured for an interaction with a mating form-fitting element of an accessory part of the plug connector.

22. The electrical plug connector according to claim 21, wherein the accessory part is designed as a connecting element, a bridging element, or a contact protection element.

23. The electrical plug connector according to claim 1, wherein the insulating housing has a fastening securing section for mechanically securing the plug connector on the carrier structure.

24. The electrical plug connector according to claim 23, wherein the fastening securing section is formed on the second housing section.

25. The electrical plug connector according to claim 1, wherein the conductor connection is designed as a spring-force clamping connection.

26. A set comprising:
the electrical plug connector according to claim 1; and
an accessory part having a mating form-fitting element suitable for interaction with the form-fitting element of the second housing section of the electrical plug connector.

27. The set according to claim 26, wherein the accessory part is designed as a connecting element for fixing the plug connector on the carrier structure.

28. The set according to claim 26, wherein the accessory part a bridging element.

29. The set according to claim 26, wherein the accessory part a contact protection element.

30. The set according to claim 26, wherein the set additionally has a contact pin strip.
